(19) United States
(12) Patent Application Publication
(10) Pub. No.: US 2004/0059753 A1
(43) Pub. Date: Mar. 25, 2004

(54) Method and apparatus for passing information between applications on a computer system

(76) Inventors: David Croft, Heidelberg (DE); Stefan Richter, Heidelberg (DE); Eric Minch, Sandhausen (DE); Stefan Weiss, Walldorf (DE); Robin Munro, Heidelberg (DE)

Correspondence Address: MCDERMOTT WILL & EMERY, 600 13TH STREET, N.W., WASHINGTON, DC, 20005-3096, US

(21) Appl. No.: 10/398,522

(22) PCT Filed: Oct. 16, 2001
(86) PCT No.: PCT/EP01/11990

(30) Foreign Application Priority Data
Dec. 20, 2000 (EP) 00127973.6

(51) Int. Cl. G06F 17/00; G06F 15/16

(52) U.S. Cl. 707/104.1; 709/201

(57) ABSTRACT

The invention relates to a method for passing information between different applications running on one or more computers comprising the following steps:

providing output information from a source application,

passing said output information to an intermediate application,

establishing, in said intermediate application, input information for a target application that is related to the output information of said source application by a predetermined rule,

passing said input information to said target application and inputting said input information to said target application,

and to a related computer system.

The invention relates to a method and apparatus for passing information between different applications running on one or more computers, e.g. computers distributed over a network, especially applications where the output of one application cannot be used as an input for the other application. The invention especially relates to the field of bioinformatics and the processing of data related to biomolecular entities.

The bio-molecular entities usually dealt with in bioinformatics include, for example, genes, proteins, enzymes, compounds, and so forth. Therefore, the analysis of biomolecular processes can start from or involve aspects such as:

gene regulation, e.g. by means of the software package arraySCOUT™ of Lion Bioscience,

protein signalling, e.g. by means of the software package πSCOUT™ of Lion Bioscience,

metabolic pathways, e.g. by the software package pathSCOUT™ by Lion Bioscience.

The arraySCOUT package is used to normalize, cluster, and otherwise analyze and display data coming from gene expression experiments, in which the quantity of messenger RNA (mRNA) corresponding to the degree of transcription for each of a large number of genes can be simultaneously measured in conditions under the experimenter's control. This technology is used in characterizing the response of a cell during various phases of its normal cycle, or during various abnormal conditions (e.g. disease, tumor formation), or in response to environmental perturbations (e.g. heat shock, toxins, nutrient change, etc.). Thus the data accessed by arraySCOUT consists of these mRNA expression levels, and the data manipulated by the user of the package refer to the corresponding genes. Individual genes or sets of genes are the items currently communicated to other packages via transformation.

The pathSCOUT package is used to access data on compounds, enzymes, and reactions in various organisms, to display, add, or modify information about these, to analyze the topology, stoichiometry, and thermodynamics of reaction networks, to search for pathways by their start and endpoints or by their stability, and to allow communication with powerful modelling packages providing advanced simulation capabilities. The data input to pathSCOUT thus consists of compounds, proteins, and reactions, and the data manipulated by the user are primarily reactions grouped into pathways. Individual proteins or sets of proteins are the items currently communicated to other packages via transformation.

The πSCOUT package is used to display information about different types of relations among proteins, e.g. whether they have been found to form complexes, whether one activates or inhibits another, whether they are co-located in the same compartment, etc. This information can be imported directly from public databases, or from proprietary databases containing experimental results, or from the output of text mining software which provides information about such interactions. The data input to πSCOUT then is pairs of proteins in some particular relation, and these are the data also manipulated by the user. Individual proteins or sets of proteins are the items currently communicated to other packages via transformation.

It should be understood that the names arraySCOUT, pathSCOUT, and πSCOUT are pending or registered trademarks of LION bioscience AG. It should also be understood that the generality of the invention is in no way restricted to communications among these three example applications, but can be extended to packages e.g. for analysis and display of data in cheminformatics, epidemiology, genome annotation and comparison, genotype/phenotype relations, genetic polymorphisms, physiological models of absorption, distribution, metabolism, excretion, and toxicity, just to mention some examples.

There is software available, e.g. the software by Lion Bioscience mentioned above, which process and evaluate data related to each of these aspects, for example there is software providing information about genes and genetic data, identified by gene names, separate software dealing with proteins and protein interactions, having protein names as input, and software dealing with enzymes, having EC (Enzyme Commission) codes as input. Although genes are of course related to proteins, the software dealing with proteins will frequently not accept genes as input and, vice versa, the application dealing with genes will not accept proteins as an input. A further problem is that the respective software may rely on different data models so that a direct exchange of objects between the applications is impossible. Also, the exchange of objects in a distributed environment via a network is not always possible. Thus, it is frequently not possible to exchange information between different applications running on the same computer system in such a manner that the output of one application serves as input for another application and thereby triggers an operation of the other application. A further problem that occurred in the past is that different applications used different names for the same biological objects, e.g. a protein, so that it was not possible to use the data designating a biological object in one application in the other application.

It is therefore an object of the present invention to provide a method and an apparatus for the exchange of information between applications where a direct exchange of objects is not possible.

According to the invention, this object is accomplished by a method for passing information between different applications running on one or more computers comprising the following steps:

providing output information from a source application,

passing said output information to an intermediate application,

establishing, in said intermediate application, input information for a target application that is related to the output information of said source application by a predetermined rule,

passing said input information to said target application and inputting said input information to said target application.

The invention may provide both that the source application, the target application and said intermediate application are installed on the same hardware and that they are distributed over a network.

The invention may especially provide that said source application and said target application are both database applications, especially database applications where the output of the source application is not compatible to the input of the target application.

The output information may especially be an identifying information for an entry in a database or for an object or a class of objects.

The method of the invention may comprise the following steps:

sending a first message from said source application to said intermediate application, said message comprising:

output information from said source application,

information designating the target application,

establishing, by said intermediate application, input data for said target application according to a predetermined rule on the basis of at least said output information contained in said message,

sending a second message containing at least said input information from said intermediate application to the target application designated in said first message.

Said information designating the target application need not necessarily be contained in said first message. For example, it may have been specified in a separate message prior to said first message, wherein this prior message may specify that until further notice all information is to be passed to a certain target application. It may also be provided that the intermediate application automatically routes output information from a certain source application, given the case, after transformation of said output information, to a specific target application.

The first message may also contain information about the source application sending the output information and/or about the type of the output information, e.g. protein, gene, or the like. The invention may provide that said first and/or second message comprises identifying information of an entry into a database under SRS.

The invention may provide that the first and/or second message comprises a transformable in the form of an object comprising the output information to be transformed or the input information resulting from the transformation of the output data from the source application, respectively. The transformable may be written in a generic format, especially as a CORBA object.

The invention may provide that said intermediate application applies a predetermined rule, e.g. implemented in said intermediate application, to the information contained in said first message when establishing said input information for the target application. It may, however, also be provided that the intermediate application decides about the rule to be applied only when receiving said first message. Especially, the invention may provide that said intermediate application determines a rule to be applied depending on information contained in said first message when establishing said input information for said target application.

The invention may provide that the intermediate application determines the rule to be applied depending on said target application, said source application and/or on the output information contained in said first message.

The invention may provide that said intermediate application uses a rule communicated by said source application, especially a rule contained or indicated in said first message from said source application to said intermediate application.

A simple rule to be followed in establishing said input data may be contained in the message itself. For more complicated rules, the message may contain a link or another indication to a location where the rule can be found.

If said first message comprises a transformable as described above, the rule to be used may be comprised in the transformable.

The invention may provide that in creating said first message output data of said source application identifying an output item, e.g. a protein, are transformed into generic identifying data and/or that in creating said second message generic identifying data used by the intermediate application are transformed to data for identifying an input item used by the target application. Thereby the problem can be overcome that different applications may use different names for the same biological object, e.g. a protein. Given the case, the translation from the specific identifying data used by the source application to generic identifying data may be performed by the intermediate application after receiving said message. Likewise, the transformation from the generic identifying data to the specific identifying data of the target application may be performed in the target application after receiving said second message.

The invention may provide that in a computer system or in a network of computers or computer systems, each application potentially passing information to another application which may need a transformation, and each application potentially receiving such information registers with the intermediate application when starting. Thus, the intermediate application knows which potential target applications are active and can process the messages received from source applications accordingly. The invention may provide a specific interapplication communication manager (IAC manager) to which every application registers that is present in the system or network. Said IAC manager handles messages from the various applications and, receiving a message from an application, determines from which application the message was received.

The invention may also provide that all information passed between source and target applications is routed via an intermediate application which checks whether the information from the source application needs transformation before passing it on to the target application and performs said transformation, if such transformation is needed, and passes the information received from the source application to the target application unchanged, if such transformation is not needed.

The invention may provide that said intermediate application is run on an interapplication communication server different from the hardware on which the source application and/or target application are run.

The invention may provide that said rule is a relation directly assigning one or more values of input variables for said target application to the value of an output variable of said source application.

The association of output variables of the source application to input variables of the target application can e.g. be established by an operation processing the data corresponding to the value of the output variable of the source application or by a table associating values of the output variable of the source application to values of input variables of the target application. In both cases, processing of the rule is done within the intermediate application without involving an application outside the intermediate application. For example, if the source application outputs data regarding gene sequences, the intermediate application may contain a look-up table containing the protein related to a certain gene sequence. The invention may provide that when receiving said first message from the source application, the intermediate application first checks its table whether it can find a match to the output information, e.g. a gene sequence, sent by the source application. If this is the case, the intermediate application performs the necessary transformation by taking the matching data from the table and putting them into the second message for the target application. If the intermediate application does not find a match in its table, it may either return an error or resort to a more elaborate processing, as set out below. Thus, it may be provided that the intermediate application itself can process frequently asked questions or standard cases, whereas for more unusual cases it uses a more elaborate routine.

The invention may provide that the rule or part of it is processed outside said intermediate application.

The invention may provide that processing said rule comprises executing a procedure comprising:

establishing a query for a database, especially on the basis of said output information, an information about the source application and/or the target application,

executing the query in said database,

determining the input information for the target application on the basis of the result of said query.

The database to be queried may be established on a different computer system.

For example, if the source application, such as pathSCOUT, outputs an enzyme, the enzyme's EC code (which the ENZYME database uses as the ID of the record) is forwarded to the intermediate application as part of an output transformable. The intermediate application obtains from the record in the ENZYME database identified by the EC code any links embedded within this record to the additional databases SWISSPROT, GenBANK, and EMBL. This may be accomplished by using the SRS command “getz”, e.g. getz ‘[enzyme-id:4.3.2.1]>swissprot’, in order to recover all links in the database SWISSPROT related to the enzyme with the EC code 4.3.2.1 (arginosuccinase). These links are then used to construct input transformables, which are then forwarded to a target application processing gene data, such as arraySCOUT.

The invention may provide that the database to be searched by the intermediate application is selected on the basis of information passed on by said source application, especially information contained in said first message.

The invention may provide that a specific database to be searched is indicated in a message passed from the source application to the intermediate application or that the intermediate application derives a database to be searched from information passed on by said source application, especially information about the target application, the source application and/or the type of the output information.

The first transformable may comprise information sufficient to establish a link to a record of said database related to said output information, said database record comprising a field directly or indirectly related to the desired input information for said target application. Said field may be specified in the first transformable or implemented in the intermediate application. The invention may provide that a first transformable to be sent from the source application to the intermediate application comprises a literal string identifying a record in an external database and that said intermediate application extracts one or more entries of a field in said record specified in said first transformable and creates a second transformable comprising a literal string identifying said entry or entries. More specifically, the invention may additionally provide that the first transformable comprises a literal string defining the type of output from the source application, e.g. enzyme, protein etc., a literal string identifying the field which identifies the record of the object in said database (e.g. the field specifying the EC code of the enzyme) and information identifying the output information in said field (e.g. the EC code of a specific enzyme).

The invention may provide that the input information to the target application comprises a link to a database. More specifically, the invention may provide that the second transformable comprises a literal string identifying the database to which the link is to be set and a specific record to which the link is directed. More specifically, the second transformable may comprise a literal string specifying a specific field in said database serving for identification of an entry and the entry in said field which is to be looked for and to which the link is set.

The invention may also provide that the first transformable identifies a certain record in a first database, that the intermediate application extracts a link to a second database entered into a field of said record of said first database which is either specified in a literal string in the first transformable or predetermined in the intermediate application for a certain target application, that the intermediate application executes the link to the second database thus extracted and that the intermediate application enters a literal string into a second transformable specifying the entry in a field of the record to which the link to the second database was set, said field having been specified in the first transformable or being predetermined in the intermediate application for a specific target application.

The invention may provide that a message is passed from the source application to the intermediate application containing information about one or more databases of which one or more are to be used by said intermediate application for evaluating said rule.

In an embodiment where a message from the source application to the intermediate application comprises a transformable, as described above, the invention may provide that the database to be used is indicated in said transformable.

The intermediate application may decide to use one of the databases indicated in said message according to an implemented rule, e.g. a rule prescribing a preferred database to be used, given the case using further information contained in said message about the source application, the target application and/or the type of output information.

The invention may provide that the intermediate application is configured to determine the links to be followed in order to find items into which the output information from the source application is to be transformed, using information about the target application which may be contained in the message from the source application.

The invention may provide that information passed on between the source application and the intermediate application and/or between the intermediate application and the target application is written in a generic format, e.g. as a CORBA object.

The invention may provide that said source application provides as output information information about genes or proteins or metabolic pathways and said target application receives as input information information about proteins, genes or metabolic pathways, wherein the type of the output information (gene, protein, etc.) of the source application is different from the type of the input to the target application.

The invention may provide that information is passed from a single source application to a plurality of target applications, wherein the intermediate application establishes for each of said target applications input information derived form one single output information item, e.g. an EC code, on the basis of a rule for the respective target application and passes each respective input information on to the respective target application.

The invention also provides a computer system comprising means for simultaneously running at least two applications adapted for exchanging information with each other, said computer system further comprising communication means for passing information between these two applications, said communication means comprising the following:

means for passing output information from a source application to an intermediate application, which may or may not be running on the computer system, for processing according to a predetermined rule to yield input information for a target application, both said source application and said target application running on said computer system,

means for receiving said input information for said target application from said intermediate application and inputting said input information to the target application.

A computer system in the sense of this patent may comprise one or more computers. Especially, a single computer is regarded as a computer system in the sense of this patent.

The invention may provide that said computer system comprises means for running said intermediate application.

The invention may provide that it is adapted to perform a method according to one of claims 1 to 12.

The invention may provide that said intermediate application is running outside said computer system, said computer system comprising means to communicate with the hardware on which the intermediate application is running.

Especially, the invention may provide that the computer system is adapted to interact with an intermediate application according to a method of one of claims 1 to 12.

Thus, the computer system is adapted to perform those steps of the method according to the invention as outlined above which relate to the source and target application and the communication of the source and target application with the intermediate application.

The invention also provides a computer system having installed thereon an application capable of communicating with other applications which may or may not be installed on the same computer system, characterized in that it comprises:

means for sending output information from said application to an intermediate application, which may or may not be running on said computer system, for processing according to a predetermined rule to yield input for a further application,

means for receiving input information for said application derived from output information of another application by said intermediate application on the basis of a predetermined rule and for inputting said information into said application.

Thus, the invention provides a computer system with at least one application that can act both as a source application and as a target application for other applications which may or may not be running on the same computer system.

The invention may provide that the computer system is adapted to communicate with said intermediate application and one or more further applications according to a method as previously described, e.g. a method according to one of claims 1 to 12.

The invention may especially provide that the computer system is adapted to perform a method according to one of claims 1 to 12.

The invention may also provide a computer system having the intermediate application, as described above, running thereon.

More specifically, the invention may provide a computer system having installed thereon an application capable of communicating with other applications and passing information between said other applications as an intermediate application, which other applications may or not be installed on the same computer system, said computer system comprising:

means for receiving output information from a source application,

means for processing said output information from said source application by said intermediate application running on the computer system according to a predetermined rule to yield input information for a target application,

means for forwarding said input information to said target application.

In this computer system the source application and/or the target application can be running on a different computer system. Especially, the computer system may be realized as an inter application communication server different from the hardware on which the source application and/or the target application are running.

The invention also provides a computer-readable storage medium comprising program code which, when executed on a computer system, causes the computer system to perform the following:

forwarding output information from a source application running on the computer system to an intermediate application, which may or may not be running on the computer system, for processing said output information according to a predetermined rule to yield input information for an application different from said source application,

receiving input information for a target application running on the computer system from an intermediate application which may or may not be running on the computer system, which has been derived by said intermediate application from the output information from an application different from said target application on the basis of a predetermined rule, and inputting said input information to said target application.

The invention may provide that the program code is configured to cause the computer system to make an application act as a source application and as a target application for other applications.

The invention may provide that said program code is configured to establish the passage of information from a first application running on the computer system, acting as a source application, to a second application, acting as a target application and running on said computer system, via said intermediate application, which may or may not be running on said computer system.

The invention also provides a computer-readable storage medium as described above, wherein said program code is configured to cause a computer system to perform a method according to one of claims 1 to 12.

The invention also provides a computer-readable storage medium comprising program code configured to cause a computer system, when executed on said computer system, to run an intermediate application for communication between a source application and a target application, said intermediate application performing the following:

receiving output information from a source application,

processing said output information from said source application according to a predetermined rule to yield input information for a target application,

forwarding said input information to said target application.

The invention may provide that the program code is configured such that said computer system is caused to establish a communication between a target application and a source application, which each may or may not be running on said computer system, according to a method of one of claims 1 to 12.

According to the invention it is possible to transform objects into each other while they are transferred between different applications. Especially, “biological objects” like e.g. genes, proteins or enzymes can be exchanged between respective applications.

A preferred embodiment of the invention involves the use of an interapplication communication server (IAC server). Especially for applications related to biological data, the data exchange via the interapplication communication server may work the following way:

1. If the user wants to send some biological object from one application (source application) to another application (target application) he/she selects the objects and specifies to which other application they should be sent to (e.g. send proteins to arraySCOUT). Internally the client site module of the IAC environment instantiates for each of the proteins a generic object called “transformable”. The transformable object contains the information which identifies the entry in the public domain databases (e.g. from SWISSPROT) corresponding to the selected protein.

2. The collection of transformables is then sent to the IAC server together with the information to which application these should be sent. Because every application registers itself during startup at the IAC server, the server “knows” to which application it should send these objects after the transformation is finished. Generally, it could also be considered to perform the generation of a generic transformable at the site of the IAC server.

3. The actual transformation of transformables is done in the IAC server by searching the public domain databases, especially databases held under SRS, for entries that are linked to the transformables which the server received from the source application. This is actually done inside a so-called transformer which is specific for a certain target application. For each application there exists a transformer that does the transformation for a datatype that the application understands. For example, the transform To-ArraySCOUTgene transformer can transform any kind of input (transformables) into gene transformables, which contain links to database entries that arraySCOUT “knows” about.

4. After the transformation is finished the newly created transformables are sent to the receiving application.

Proceeding in this way especially provides the following advantages:

1. In modular and extendable design it is possible to exchange any kind of biological objects that have a corresponding SRS database entry.

2. The actual transformation process can be extended in a way that one searches not only the corresponding linked entries in other databases, but also filters the result by certain constraints (e.g. filter by organism and so forth).

3. It is possible to exchange biological objects between applications running on different computers, because the IAC server works in a network environment.

The application will be further exemplified with reference to the appended drawings and to specific, non-limiting examples of embodiments of the invention.

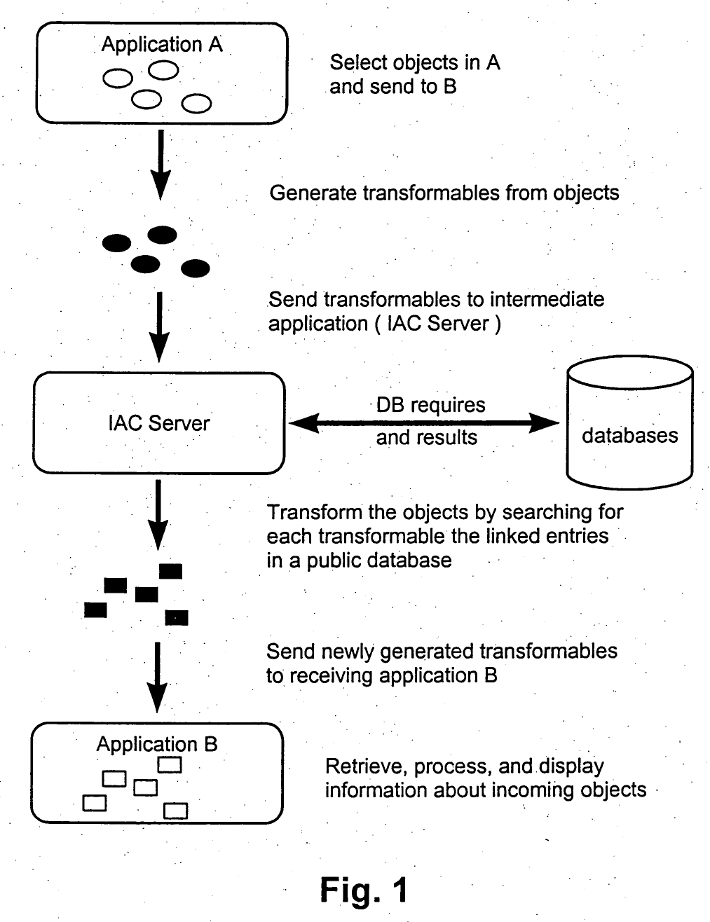

FIG. 1 shows a simplified scheme of an embodiment of the invention,

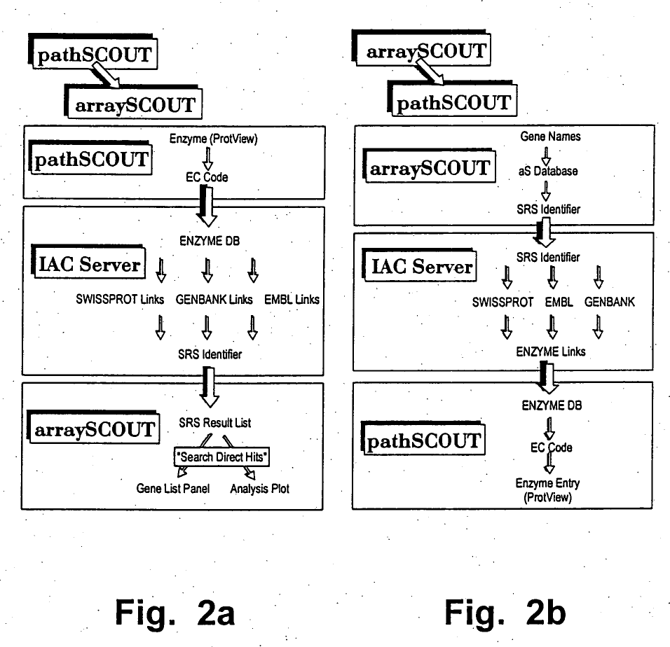

FIG. 2a exemplifies the transfer of data between pathSCOUT and arraySCOUT,

FIG. 2b exemplifies the transfer of data from arraySCOUT to pathSCOUT,

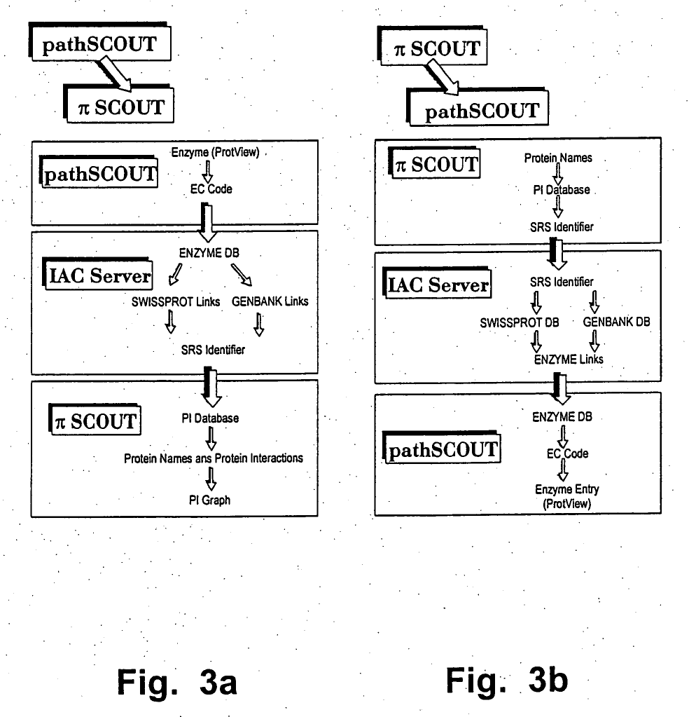

FIG. 3a exemplifies the transfer of data from pathSCOUT to πSCOUT,

FIG. 3b exemplifies the transfer of data from πSCOUT to pathSCOUT,

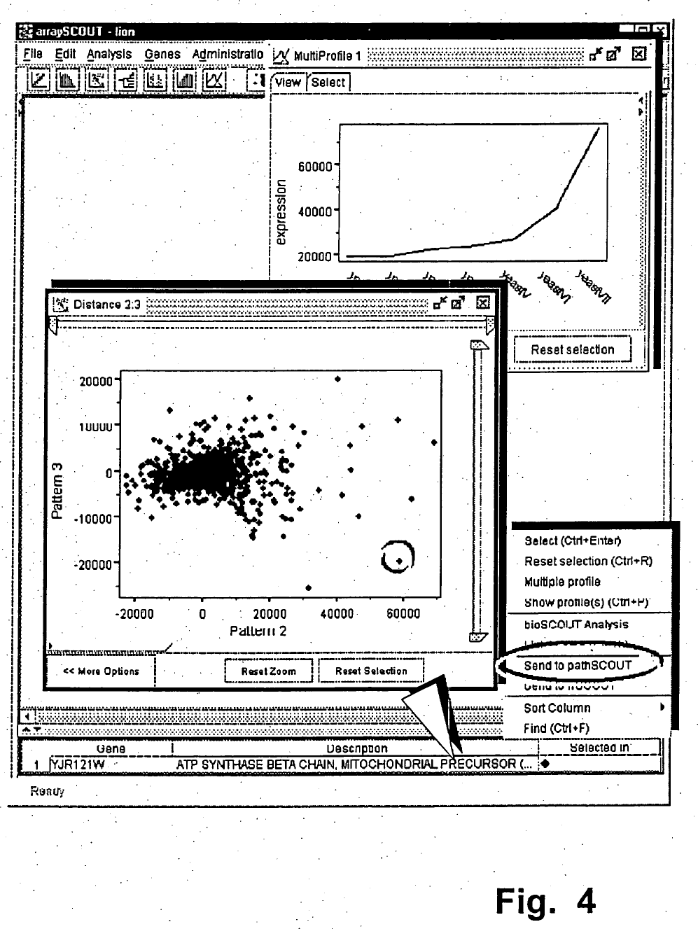

FIG. 4 is a screen shot exemplifying the submission of ATP synthase β chain to pathSCOUT

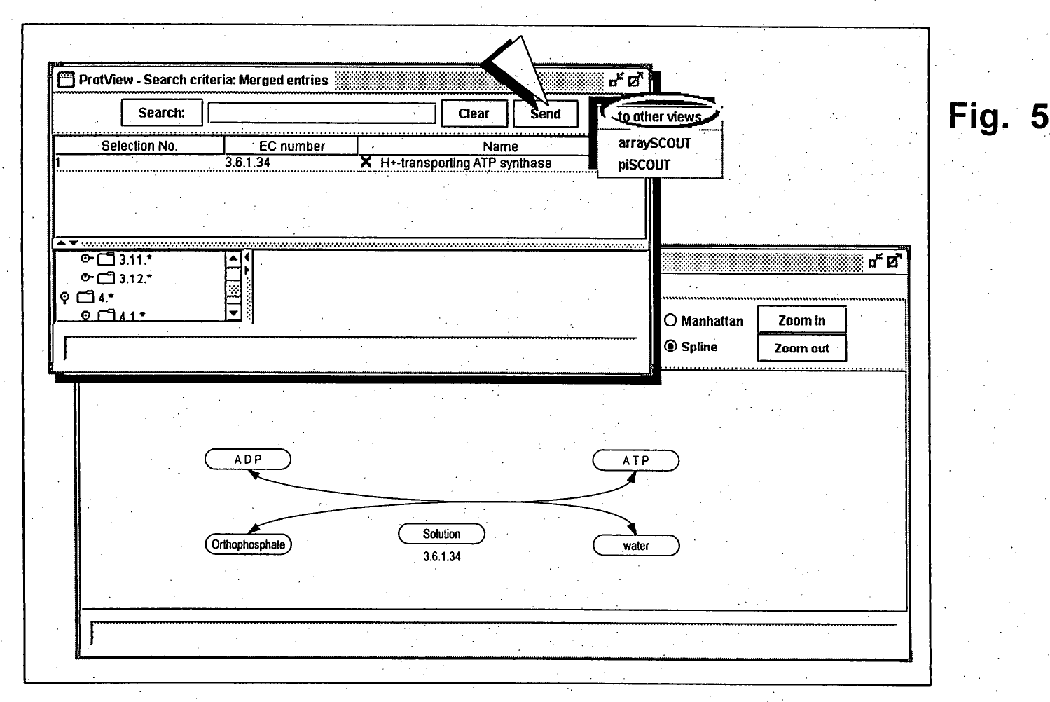

FIG. 5 is a screen shot showing the ATP synthase reaction,

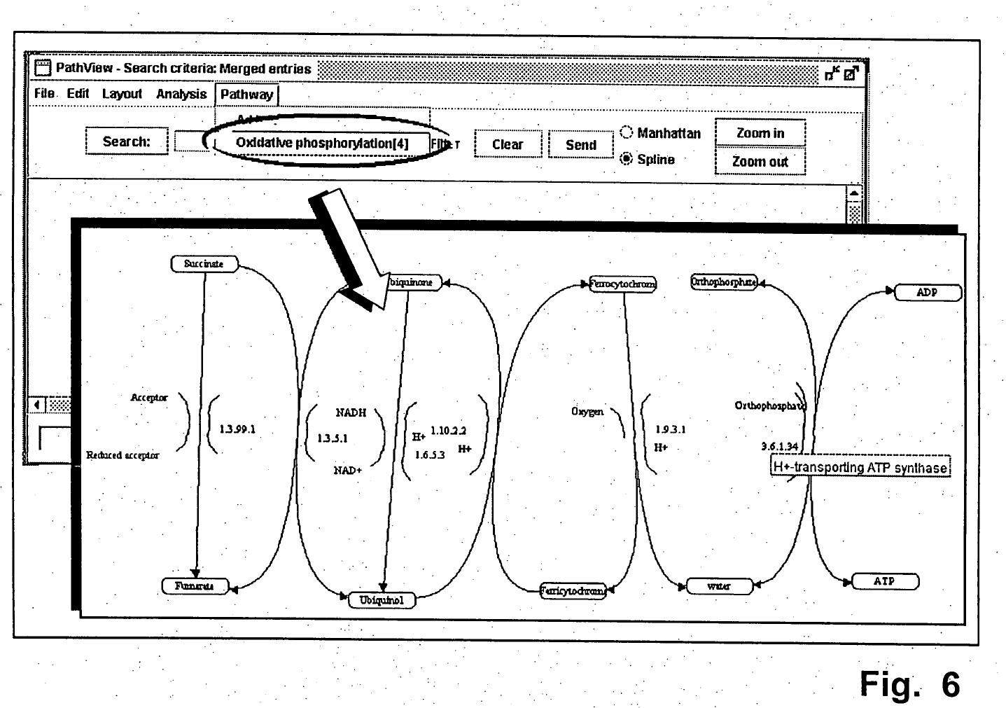

FIG. 6 is a screen shot showing the topological assignment of the ATP synthase reaction,

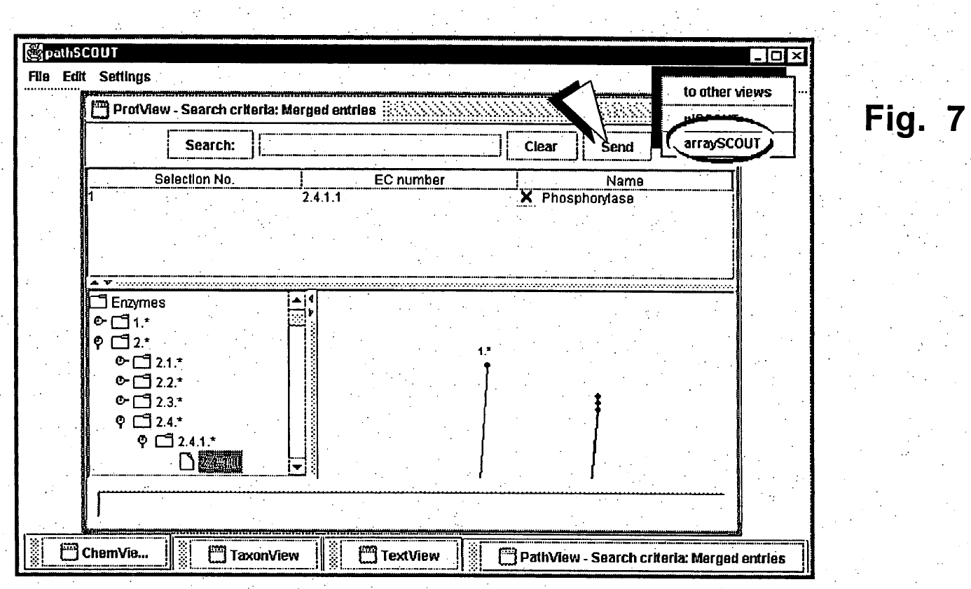

FIG. 7 is a screen shot exemplifying the submission of an enzyme to arraySCOUT,

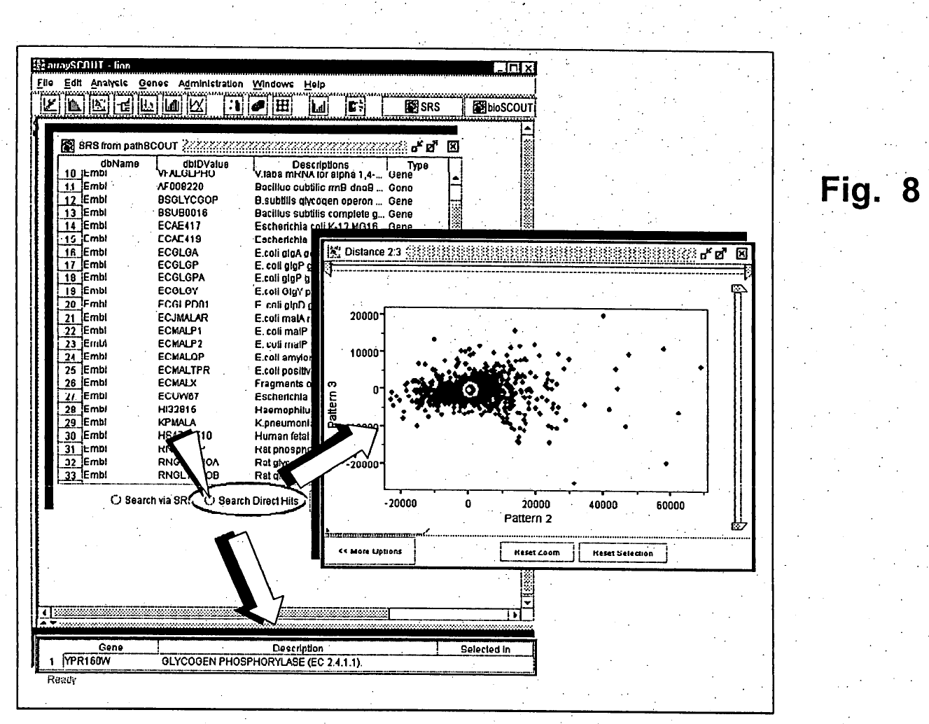

FIG. 8 is a screen shot exemplifying the investigation of the expression profile of glycogen phosphorylase in arraySCOUT,

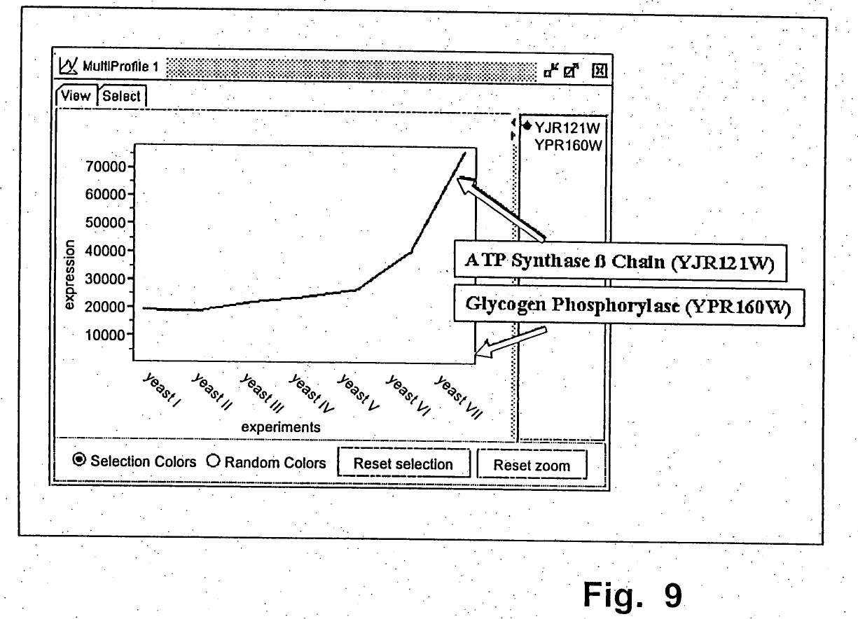

FIG. 9 is a screen shot showing the expression profile comparison for ATP synthase β chain and glycogen phosphorylase,

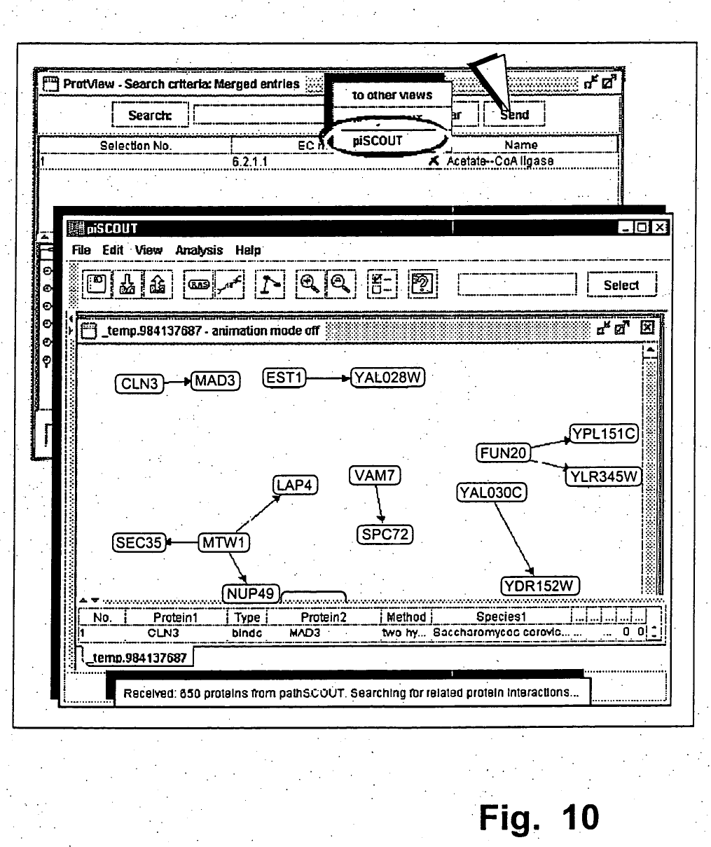

FIG. 10 is a screen shot exemplifying the submission of an enzyme to πSCOUT

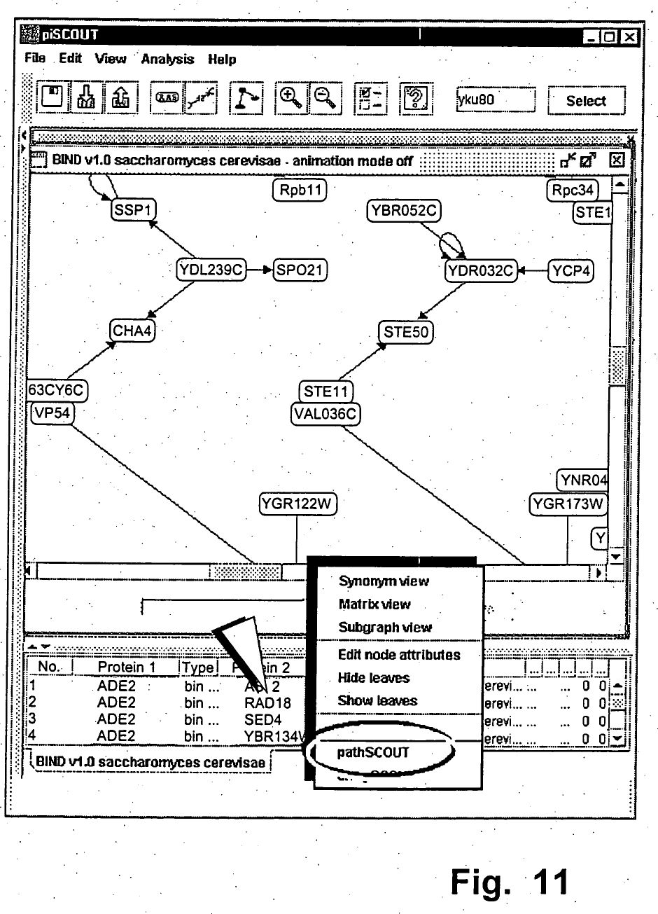

FIG. 11 is a screen shot exemplifying the submission of a complete protein interaction list to pathSCOUT,

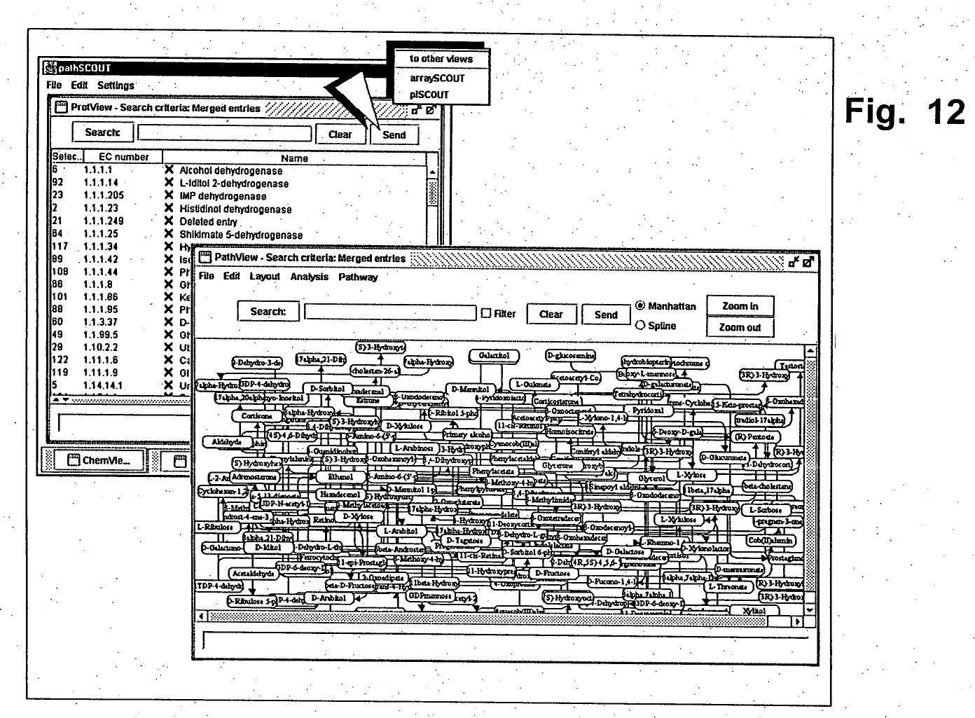

FIG. 12 is a screen shot showing the reaction network supported by the enzyme set received from πSCOUT.

FIG. 1 generally exemplifies the process of sending information from an application A to an application B utilizing an intermediate application on the IAC server. An application A is going to send objects to application B. Application A generates transformables from the objects to be sent. These transformables contain information about entries of a database, e.g. an SRS database, that are linked to the objects. For example, if the object sent by application A is a protein, the transformable includes the ID of the protein, together with the name of the respective identifying field specifying this protein's entry in the database, and a specification that the related gene is to be retrieved. The transformable is sent to an IAC server. Based on the information contained in the transformable the IAC server submits a query to a database, e.g. a query to SWISSPROT, to look for the gene related to said protein. The result of the query, e.g. the gene, is returned to the IAC server which generates a new transformable for application B as the receiving application. Creating the second transformable for the target application, the intermediate application transforms the objects from the source application, by searching for each transformable the linked entries in a public database that is know to the receiving application and specifies those linked entries in the second transformable to be sent to the target application.

Subsequently, the data exchange between arraySCOUT, pathSCOUT, and πSCOUT is exemplified in more detail.

The combined application of pathSCOUT™ together with its associated software packages arraySCOUT™ and πSCOUT™ allows the user to investigate metabolic changes caused by gene regulation as well as protein signalling-mediated metabolic adaptations. Data sharing is handled by an inter-application communication (IAC) server. The IAC server receives data from the source application and forwards reprocessed data to the target application. The subsequent section explains the principles of data sharing between pathSCOUT™, arraySCOUT™ and πSCOUT™ and introduces different options to elucidate metabolic consequences of gene regulatory events and to investigate cross-communication between protein signalling routes and metabolic reaction networks.

Data Exchange via the Inter-Application Server

The molecular entities dealt with are coded as genes, interact as proteins, and catalyze biochemical reactions as enzymes.

arraySCOUT analyzes genes (identified by gene names), πSCOUT handles proteins (identified by protein names), and pathSCOUT deals with enzymes (identified by EC codes). The interapplication communication (IAC) server allows the user to trace the corresponding elements of one molecular entity on all three levels. Gene collections (arraySCOUT), protein ensembles (πSCOUT), or enzyme sets (pathSCOUT) are submitted from a source application to the IAC server which forwards SRS identifiers. The target application uses the SRS identifier database links to find the corresponding genes, proteins, and enzymes, respectively.

Communication between pathSCOUT and arraySCOUT

Every record in every database which refers to a particular object or entry (as opposed to an association between entries), whether an SRS flat file or a relational or object oriented database, is uniquely identified by some field. These fields may have different names in different databases (though the name “ID” is typically used). In most enzyme databases, the ID code used is usually the EC (Enzyme Commission) code. The EC code thus functions as an SRS ID for flat file enzyme databases, or in general as a record ID.

The ProtView application implemented in pathSCOUT handles enzymes by their EC codes. When the “Send >arraySCOUT function” is activated, the ProtView constructs a transformable for each selected enzyme. A transformable is a CORBA object consisting of an object type specified by a literal string (e.g. “Enzyme”), a DBLink (database link), and an optional vector of weighting values. The DBLink consists of literal strings specifying the name of the database (e.g. “ENZYME”), its type (e.g. “SEQRELATED”), the name of the field which identifies the record of the object in the database (e.g. “ID”), the actual ID of the object (e.g. “4.1.3.18”), and a description (e.g. “ACETOLACTATE SYNTHASE”). The weights are used to communicate associated information such as expression level, concentration, activity, evidential confidence, statistical significance, etc., and are ignored by the IAC server, being only passed on for use by the receiving application.

Both transformables and DBlinks, as well as several other ancillary CORBA data types required for the IAC client/server communication, are defined in the Interface Definition Language (IDL) file Transformer.idl (explanatory information on IDL and other CORBA standards can be found at www.omg.org/gettingstarted/corbafaq.htm; more technical detail at www.omg.org/technology/documents/specifications.htm). The IDL definitions for transformables and for DBlinks, excerpted from the transformer module of Transformer.idl, are below:

struct DBLink {

string dbName;
string dbLibrary;
string dbIDFieldName;
string dbIDValue;
string description;

};
typedef sequence<DBLink> DBLinks;
struct Transformable {

string objectType;
DBLinks srsLinks;
floats weights;

};
typedef sequence<Transformable> Transformables;

These definitions simply specify that a DBLink consists of the five strings described above, and that a transformable consists of the object type as a string, a sequence of DBLinks corresponding to SRS links, and a sequence of floating point numbers, also as described. The corresponding Java code for the transformable, automatically generated from the IDL, is below:

final public class Transformable implements

org.omg.CORBA.portable.IDLEntity {
public Transformable( ) {
}
public Transformable(String objectType, DBLink[] srsLinks) {

this.objectType = objectType;
this.srsLinks = srsLinks;
weights = new float[0];

}
public Transformable(String objectType,

DBLink[] srsLinks, float[] weights) {
this.objectType = objectType;
this.srsLinks = srsLinks;
this.weights = weights;

}
public String objectType;
public DBLink[] srsLinks;
public float[] weights;
}

An IACListener interface is defined, which requires only that any client implement a method called “communicationPerformed”, which takes an IACevent as an argument. The IACevent consists only of a source (specifying the sending application), and a list of transformables. The Java code within a particular view manager of the pathSCOUT application which implements the IACListener interface appears as follows:

public void communicationPerformed(IACEvent e) {

Transformable[] transformables = e.getTransformables( );
if (transformables.length > 0) {

Vector basicInfos = new Vector( );
for (int i = 0; i < transformables.length; i++) {

if (transformables[i].objectType.equals(“Enzyme”)) {

BasicInfo basicInfo = new BasicInfo( );
basicInfo.object_type = new EnzymeSchema( ).
CLASS;
basicInfo.id = bioSchema.composeObjectId(

transformables[i].srsLinks[0].dbIDValue,
new EnzymeSchema( ));

basicInfos.addElement(basicInfo);

}

}

if (basicInfos.size( ) > 0)

selectionPerformed(

new SelectionEvent(e.getSource( ),basicInfos));

}
else {

Publisher publisher = (Publisher)e.getSource( );
JOptionPane.showMessageDialog(null,publisher.name+

“tried to send some objects to pathSCOUT”+
“\nbut no enzymes were included.”,
“ProtView message”,JOptionPane.INFORMATION_{—}
MESSAGE);

}

}

The transformable is sent to the IAC server, which retrieves the corresponding enzyme record for the specified database (e.g. the ENZYME database), using the ID information. In the above method, the sequence of transformables is retrieved from the IACEvent, and each is checked to see if it is the appropriate type (Enzyme, in this case). If so, the link information in the transformable is used to retrieve the database ID for an enzyme, and this is then used further in the application to select and highlight the incoming enzymes.

Under SRS, each database record may contain links to zero, one, or more records in zero, one, or more other databases (e.g. SWISSPROT, GenBANK etc.). Similar information is also obtainable within relational or object oriented databases through the use of embedded or associated foreign keys or pointers. The IAC server retrieves link information corresponding to the links specified within the transformable.

This link information is then used to construct zero, one, or more input transformables for each of the output transformables. In the present example, one of these links would be to the SWISSPROT record ILVI_HAEIN so the corresponding transformable would contain the object type “Protein” and a DBLink consisting of the database name “SWISSPROT”, database type “SEQUENCE”, ID field name “ID”, the ID value “ILVI_HAEIN”, and the description “ACETOLACTATE SYNTHASE LARGE SUBUNIT”.

The resulting newly generated input transformables are then sent to array SCOUT, which uses the database name (SWISSPROT) and type, the ID field name (ID), and the ID field value (ILVI_HAEIN) to query the database for the record corresponding to each input transformable, and presents these in a separate window. Since EC codes specify only a catalytic function, but do not differentiate between isozymes or consider a particular enzyme's species of origin, the result list can present multiple database entries for each enzyme submitted from pathSCOUT. Activating the “Search Direct Hits” function by clicking its button detects the presence of any incoming records among the current experiment group, and distinctively highlights the corresponding rows in the gene list panel and the corresponding data points in the profile distance plot (FIG. 2a; FIG. 8).

For example, when the pathSCOUT application sends enzymes to other applications, the following method is called:

public void sendSelectionToApplication(String appName,

Vector basicInfoAdapters) {
Transformable transformable;
Transformable[] transformables;
Vector transformableVector = new Vector( );
for (int i = 0; i < basicInfoAdapters.size( ); i++) {

try {

BasicInfo basicInfo = ((BasicInfoAdapter)

basicInfoAdapters.elementAt(i)).getBasicInfo( );

DBLink[] dblinks = new DBLink[1];
dblinks[0] = new DBLink(“Enzyme”, “SeqRelated”,

“ID” bioSchema.extractDbId(basicInfo.id), “”);

transformable = new Transformable(“Enzyme”,dblinks);
transformableVector.addElement(transformable);

}
catch(IdentifierNotResolvable ex) {

JOptionPane.showMessageDialog(null,

“The enzyme ID is not resolvable.\n”+
“Please contact your system administrator.”,
“Server error”,JOptionPane.ERROR_MESSAGE);

}
catch(org.omg.CORBA.SystemException e) {

JOptionPane.showMessageDialog(null,

“The BioData server is not responding.\n”+
“Please contact your system administrator.”,
“Server error”,JOptionPane.ERROR_MESSAGE);

}

}
transformables = new Transformable[transformableVector.size( )];
transformableVector.copyInto(transformables);
viewerManager.getIACManager( ).sendEnzymesTo(appName,
transformables);

}

The above method is called with two arguments: the name of the destination application (appName), and the identifying information for the enzymes (basicInfoAdapters). The method processes the list of enzymes by creating for each an array of DBLinks consisting of a single DBLink item with the five strings “Enzyme”, “SeqRelated”, “ID”, the ID itself, and the description; thus the DBLink item for acetolactate synthase would be (“Enzyme”, “SeqRelated”, “ID”, “4.1.3.18”, “ ”), i.e., the description in this case may be empty. A transformable is then created using the object type “Enzyme” and the single-element array of DBLinks. Optionally, the transformable could also be created with a vector of floating-point weights. After new transformables are created for all enzymes in the list (barring unresolvable IDs or server crashes), the IAC manager is called with the name of the receiving application and the list of transformables, to be processed at the receiving end by its communicationperformed method.

If, for example, the receiving application is arraySCOUT, and only the single enzyme acetolactate synthase is to be sent, the last line of the sendSelectionToApplication method sends to pathSCOUT's IAC manager a sendEnzymesTo message, with the arguments “arraySCOUT” and a single-element array of output transformables. The single transformable in this array has the object type “Enzyme” and a single-element array of DBLinks. The single DBLink is described above, so the total message is: “arraySCOUT”, ((“Enzyme”, (“Enzyme”, “SeqRelated”, “ID”, “4.1.3.18”,””))). When this message is received, the IAC manager sends it on to the central transformation server in a sendBioObjectsToSubscriber message. The information about the sender, receiver, and data type is used to determine the data type of the input transformables into which the output transformables are to be transformed, and the appropriate Transformer is instantiated, in this case a TransformToArraySCOUTGene. The TransformToArraySCOUTGene transformer then processes each of the output transformables to obtain its SRS links, whether direct or indirect, to either GENBANK or EMBL, which contain gene records. For each such gene record retrieved, a new input transformable is created, e.g., in case of the above-mentioned link to ILVI_HAEIN and of a link to EMBL (“Gene”, (“EMBL”, “Sequence”, “ID”, “HI32832”,””)), and finally sent on to arraySCOUT for further display and analysis.

The reverse process starts with gene names in array SCOUT and ends up with enzyme entries displayed in pathSCOUT's ProtView (FIG. 2b; FIG. 5).

Communication Between pathSCOUT and πSCOUT

In the case of an enzyme submission to πSCOUT (“Send >πSCOUT”), the IAC server forwards SWISSPROT and GENBANK SRS identifiers. πSCOUT screens all protein interaction lists/tables present in the list panel. The interactions of proteins linked to incoming SRS identifiers are collected in a temporary PI (protein interaction) list and a corresponding protein interaction graph is generated in a separate window (FIG. 3a). The reverse process is illustrated in FIG. 3b.

Metabolic Consequences of Gene Regulatory Events

Data Exchange with arraySCOUT

The regulation of cellular metabolism occurs on different levels. Substrate accessibility can be modified via specific transporter proteins. Immediate adaptions to changing metabolic requirements are achieved by allosteric regulation or the covalent modification of enzymes controlling key positions (“bottlenecks”) in the biochemical network. Metabolic long-term regulations, however, are realized via gene regulation. The metabolic implications of such gene-regulatory events can be investigated by combining pathway investigations (pathSCOUT) with genome-wide expression analysis (arraySCOUT).

arraySCOUT provides a collection of methods for the analysis of expression data. One such tool, the profile distance plot, generates two-dimensional plots of the gene profiles in a way that genes differing significantly from the average form outliers on the plot. To identify the corresponding genes profile dots can be selected by dragging the left mouse button to draw a selection box around the dots. The selected dot gets highlighted and appears as a name entry in the gene list panel. It can be sent to pathSCOUT by choosing “Send to pathSCOUT” from the gene list mouse menu.

In the example shown, yeast expression data recorded during the diauxic shift are presented in a profile distance plot. If grown in sugar rich media, yeast fuels its “metabolic engine” merely by glycolysis. Glucose is broken down to pyruvate which gets decarboxylated to acetaldehyde. Alcohol dehydrogenase re-establishes the oxidized status of hydrogen acceptors (NAD+) needed to run glycolysis by reducing acetaldehyde to ethanol. When the fermentable glucose is exhausted, ethanol is reutilized as carbon and an energy source for aerobic growth (“diauxic shift”).

In FIG. 4, the gene for mitochondrial ATP synthase β chain has been identified as an outlier. The gene profile view reveals a significant upregulation of the gene's activity during the diauxic shift (FIG. 9). The selected gene is sent to pathSCOUT by choosing “Send to pathSCOUT” from the gene list mouse menu. pathSCOUT receives the EC code, searches the ENZYME database and presents the recovered enzyme in the enzyme selection list of the ProtView. The catalytic activity can be viewed in the PathView after sending the enzyme to the “other viewers” (FIG. 9, 5). The Pathway menu list “Oxidative phosphorylation” as an associated pathway. Loading the pathway reveals the position of ATP synthase within the respiratory chain (FIG. 6).

The result fits very well with the underlying metabolic processes. After the oxidation of ethanol to acetate and coupling to its coenzyme A it is fed into the citrate cycle, which oxidizes the remaining carbons to CO₂ and forwards hydrogens via NAD+ and FAD to the respiratory chain. The energy release from burning hydrogen to water is finally used to drive the electrochemical ATP generators (ATP synthase) of the inner mitochondrial membrane.

pathSCOUT allows the user to send potential candidates for gene regulation to arraySCOUT. The enzyme is submitted from ProtView (FIG. 7).

arraySCOUT presents all SRS identifiers received from the IAC server in a separate window. Clicking on the “Search Direct Hits” radio button launches a query in the gene list of the currently open experiment group. Hits ate presented in the gene list panel and the gene profile (dot) is highlighted in the profile distance plot (FIG. 8).

In the current example, glycogen phosphorylase as one regulator of the glycogen metabolism has been investigated. The gene coding for the yeast phosphorylase turns out not to respond strongly during the diauxic shift. The gene profile resides withing the scatter cloud focus of a profile distance plot (FIG. 8, 9). Glycogen phosphorylase shows no significant induction when compared to the gene profile of ATP synthase β chain (FIG. 8). These results agree with the fact that glycogen degradation is not significantly influenced by the diauxic shift.

Metabolic Pathways and Protein Interaction Networks

Data Exchange with πSCOUT

Signals between metabolic pathways and protein signalling networks are exchanged in both directions:

Metabolic pathways are regulated by protein signalling events (e.g., phosphorylation of glycogen phosphorylase).

Compounds generated in metabolic processes interfere with the activity of signalling proteins (e.g., inositol phosphates).

Besides their involvement in growth regulation and cell differentiation, protein signalling routes target key enzymes of metabolic pathways. The activity of such enzymes is sensitive to conformational changes as well as covalent modifications. Data exchange between pathSCOUT and πSCOUT allows the user to investigate cross-communication between metabolic pathways and protein signalling networks.

The diauxic shift of yeast involves ethanol reutilization, which starts with the re-oxidation of ethanol to acetaldehyd and acetate. Acetate CoA ligase couples acetate to coenzyme A to result in acetyl-CoA, which is fed into the citrate cycle.

Besides the upregulation of gene activities, it is feasible to consider protein interaction-mediated enzyme activation as a mechanism for metabolic adjustments. In the example shown in FIGS. 9 to 10, acetate CoA ligase has been submitted to πSCOUT to point out possible protein interaction events associated with the re-entry of ethanol into the yeast metabolism. As depicted in the status bar, πSCOUT receives 650 SRS identifiers which are used to screen the currently-available protein interaction (PI) databases. πSCOUT automatically integrates the recovered proteins into a PI graph and enters the interactions in the PI list (FIG. 10).

To identify enzymes which participate in a given protein signalling network, all proteins (“nodes”) of a PI graph can be selected, and the complete protein set can be submitted to pathSCOUT (FIG. 11). Corresponding enzyme entries are recovered from the ENZYME database and entered in the selection list of the ProtView. Sending the enzyme selection list to the other viewers allows the user to review the metabolic pathways supported by the enzyme set (FIG. 11).

The features disclosed in the specification, the claims and the drawings, taken alone or in any combination thereof, can be material for realizing the invention in its various embodiments.

1. Method for passing information between different applications running on one or more computers comprising the following steps:
providing output information from a source application,
passing said output information to an intermediate application,
establishing, in said intermediate application, input information for a target application that is related to the output information of said source application by a predetermined rule,
passing said input information to said target application and inputting said input information to said target application.

2. Method according to claim 1 comprising the following steps:
sending a first message from said source application to said intermediate application, said message comprising:
output information from said source application,
information designating a target application,
establishing, by said intermediate application, input data for said target application according to a predetermined rule on the basis of at least said output information contained in said message,
sending a second message containing at least said input information from said intermediate application to the target application designated in said first message.

3. Method according to claim 2, wherein said intermediate application applies a predetermined rule to the information contained in said first message when establishing said input information for said target application.

4. Method according to one of claims 1 or 2, characterized in that said intermediate application uses a rule communicated by said source application.

5. Method according to one of claims 1 to 4, wherein said intermediate application is run on an interapplication communication server different from the hardware on which the source application and/or target application are run.

6. Method according to one of claims 1 to 5, wherein said rule is a relation directly assigning one or more values of input variables for said target application to the value of an output variable of said source application.

7. Method according to one of claims 1 to 6, wherein processing said rule comprises executing a procedure comprising:
establishing a query for a database on the basis of said output information,
executing the query in said database,
determining the input information for that target application on the basis of the result of said query.

8. Method according to claim 7, characterized in that the database to be searched by the intermediate application is selected on the basis of information passed on by said source application.

9. Method according to claim 7, characterized in that a message is passed from the source application to the intermediate application containing information about one or more databases of which one or more are to be used by said intermediate application for evaluating said rule.

10. Method according to one of claims 1 to 9, characterized in that information passed on between the source application and the intermediate application is in a generic format.

11. Method according to one of claims 1 to 10, characterized in that said source application provides as output information information about genes or proteins or metabolic pathways and said target application receives as input information information about proteins, genes or metabolic pathways, wherein the type of the output information of the source application is different from the type of the input to the target application.

12. Method according to one of claims 1 to 11, characterized in that information is passed from a single source application to a plurality of target applications, wherein the intermediate application establishes for each of said target applications input information derived from one output information item on the basis of a rule for the respective target application and passes each respective input information on to the respective target application.

13. Computer system comprising means for simultaneously running at least two applications adapted for exchanging information with each other, said computer system further comprising communication means for passing information between these two applications, said communication means comprising the following:
means for passing output information from a source application to an intermediate application for processing according to a predetermined rule to yield input information for a target application, both said source application and said target application running on said computer system,
means for receiving said input information for said target application from said intermediate application and inputting said input information to the target application.

14. Computer system according to claim 13, characterized in that said computer system comprises means for running said intermediate application.

15. Computer system according to claim 13 or 14, characterized in that it is adapted to perform a method according to one of claims 1 to 12.

16. Computer system according to claim 13, characterized in that said intermediate application is running outside said computer system, said computer system comprising means to communicate with the hardware on which the intermediate application is running.

17. Computer system according to claim 16, characterized in that the computer system is adapted to interact with an intermediate application according to a method of one of claims 1 to 12.

18. Computer system having installed thereon an application capable of communicating with other applications which may or may not be installed on the same computer system, characterized in that it comprises:
means for sending output information from said application to an intermediate application, which may or may not be running on said computer system, for processing according to a predetermined rule to yield input for a further application,
means for receiving input information for said application derived from output information of another application by said intermediate application on the basis of a predetermined rule and for inputting said information into said application.

19. Computer system having installed thereon an application capable of communicating with other applications which may or may not be installed on the same computer system, characterized in that it comprises:
means for receiving output information from a source application,
means for processing, by said application installed on the computer system, said output information from said source application according to a predetermined rule to yield input information for a target application,
means for forwarding said input information to said target application.

20. Computer program, which, when executed on a computer system, causes a computer system to perform the following:
forwarding output information from a source application running on the computer system to an intermediate application for processing said output information according to a predetermined rule to yield input information for an application different from said source application,
receiving input information for a target application running on the computer system from an intermediate application which has been derived by said intermediate application from the output information from an application different from said target application on the basis of a predetermined rule and inputting said input information to said target application.

21. Computer program according to claim 20, characterized in that the program is configured to cause the computer system to make an application act as a source application and as a target application for other applications.

22 Computer program according to claim 20 or 21, characterized in that said program is configured to establish the passage of information from a first application running on the computer system, acting as a source application, to a second application, acting as a target application and running on said computer system, via said intermediate application, which may or may not be running on said computer system.

23. Computer program according to one of claims 20 to 22, characterized in that said program is configured to cause a computer system to perform a method according to one of claims 1 to 12.

24. Computer program configured to cause a computer system, when executed on said computer system, to run an intermediate application for communication between a source application and a target application, said intermediate application performing the following:
receiving output information from a source application,
processing said output information from said source application according to a predetermined rule to yield input information for a target application,
forwarding said input information to said target application.

25. Computer-readable storage medium comprising program code configured to cause a computer system, when executed on said computer system, to run a program according to one of claims 20 to 24.
